(19) United States
(12) Patent Application Publication
(10) Pub. No.: US 2004/0003123 A1
(43) Pub. Date: Jan. 1, 2004

(54) Method and system for managing time information necessary for an embedded system

(76) Inventor: Hung-Rok Kwon, Suwon-shi (KR)

Correspondence Address: ROBERT E. BUSHNELL, 1522 K STREET NW, SUITE 300, WASHINGTON, DC, 200051202

(21) Appl. No.: 10/184,065

(22) Filed: Jun. 28, 2002

(51) Int. Cl. G06F 15/16

(52) U.S. Cl. 709/248

(57) ABSTRACT

A time information management method and system for providing time information necessary for an embedded system, without using a hardware real-time clock device. The method and system comprises accessing a time server providing real-time information through the Internet during system initialization; acquiring the real-time information from the time server through a message exchange with the time server; and defining the acquired real-time information as the system's time information and updating the time information depending on a timer operation of the real-time operating system.

### BACKGROUND OF THE INVENTION

1. Field of the Invention

The present invention relates generally to an embedded system, and in particular, to a method and system that manages time information used during the operation of an embedded system with an Internet access function.

2. Description of the Related Art

An embedded system refers to a system employing a real-time operating system (i.e., a “RTOS”. By way of example, an embedded system may be constructed to include a webphone and a digital personal assistant (i.e., a “PDA”). The embedded system provides time information that is used while driving the system by using a real-time clock device, similar to a general-purpose, or stand-along computer. In contemporary practice, a real-time clock device is often a discrete timer circuit powered with a built-in battery. Initial time information of the real-time clock device is set by a real-time clock manager based on current time information that is typically manually input by a user of the system. Thereafter, the real-time clock device continuously updates time information starting with the initial time information supplied by the user, and sequentially provides the updated time information to the real-time clock manager.

The real-time clock device maintains the time information using by its battery power even when an external source of electrical power to the computer system is interrupted. Upon reception of an internal request for time information from a software application, the real-time clock manager provides that application with the time information obtained from the real-time clock device. An exemplar of one effort to implement a simple network time protocol (i.e., a “SNTP”) is found in RFC2030 Version 4 issued by the Network Working Group. Accordingly, the embedded system continuously uses the real-time clock device in order to acquire time information required in driving the system. I have noticed however, that this dependency on the use of a real-time clock circuit results in an increase in the hardware complexity and the cost of the embedded system.

### SUMMARY OF THE INVENTION

It is, therefore, an object of the present invention to provide an improved time information management process and system.

It is another object to provide a time information management method and system for providing time information needed for an embedded system, without using a hardware device.

These and other objects may be achieved with a process for managing time information in an embedded system with an Internet access function, by using a real-time operating system (RTOS). A time server is accessed to obtain real-time information through the Internet during system initialization. The real-time information is acquired from a time server through exchanges of messages with the time server. The acquired real-time information is defined as the time information, and the time information is updated on the basis on a timer operation of the real-time operating system.

This process also contemplated the storage of the updated time information in a nonvolatile memory when the system is turned off at a request of a user or at a predetermined time. If the acquired real-time information falls behind the time information stored in the nonvolatile memory, a message may be initiated to request an input of a current time information input request message, and the system then receives current time information.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 illustrates a system that manages time information for an embedded system;

FIG. 2 illustrates a schematic block diagram for an embedded system constructed according to the principles of the present invention;

FIG. 3 illustrates a system for managing time information for an embedded system according to a preferred embodiment of the present invention; and

FIG. 4 is a flow chart that illustrates an operating process of a real-time clock manager for one embodiment constructed according to the principles of the present invention.

### DETAILED DESCRIPTION OF THE PREFERRED EMBODIMENT

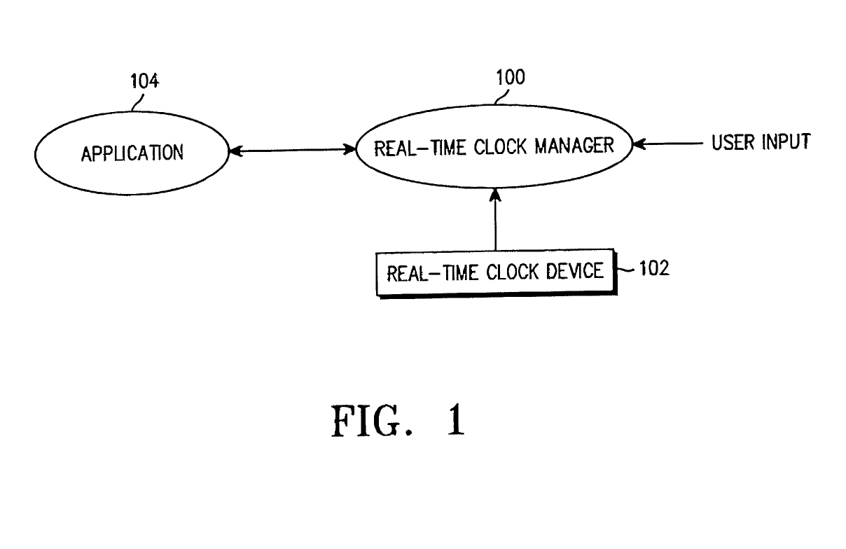

Turning now to the drawings, an embedded system as illustrated by FIG. 1, provides time information required for driving the system using a real-time clock device 102. Initial time information of the real-time clock device 102 is set by a real-time clock manager 100 based on current time information input by a user. Thereafter, the real-time clock device 102 continuously updates time information starting from the initial time information, and provides the updated time information to the real-time clock manager 100. The real-time clock device 102 maintains the time information using its battery power even when the system power is cut off. Upon receipt of a time information request from an application 104, the real-time clock manager 100 provides the application 104 with the time information provided from the real-time clock device 102.

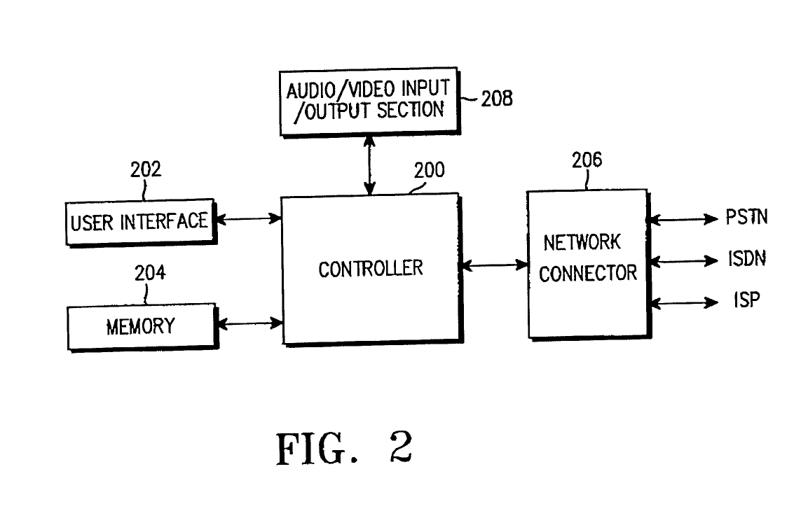

According to the present invention, for our discussion of an embedded system we will refer to a webphone (FIG. 2) capable of providing Internet service, call service, packet service and multimedia (audio/video) service, wherein the elements not necessary for a description of the present invention are not shown for simplicity.

Referring to FIG. 2, a controller 200 is connected to a public switched telephone network (i.e., a “PSTN”), an integrated services digital network (i.e., an “ISDN”) and an internet service provider (i.e., an “ISP”) through a network connector 206.

A user interface 202 includes user input/output devices (not shown), such as a keypad, a keyboard, a touch-screen panel and an integrated circuit (i.e., an “IC”) card reader, for providing data input by the user to the controller 200 and for displaying various information under the control of the controller 200.

An audio/video input/output section 208 is connected to an undepicted camera, a liquid crystal display (i.e., a “LCD”), microphone and speaker, and inputs/outputs audio and video data under the control of the controller 200.

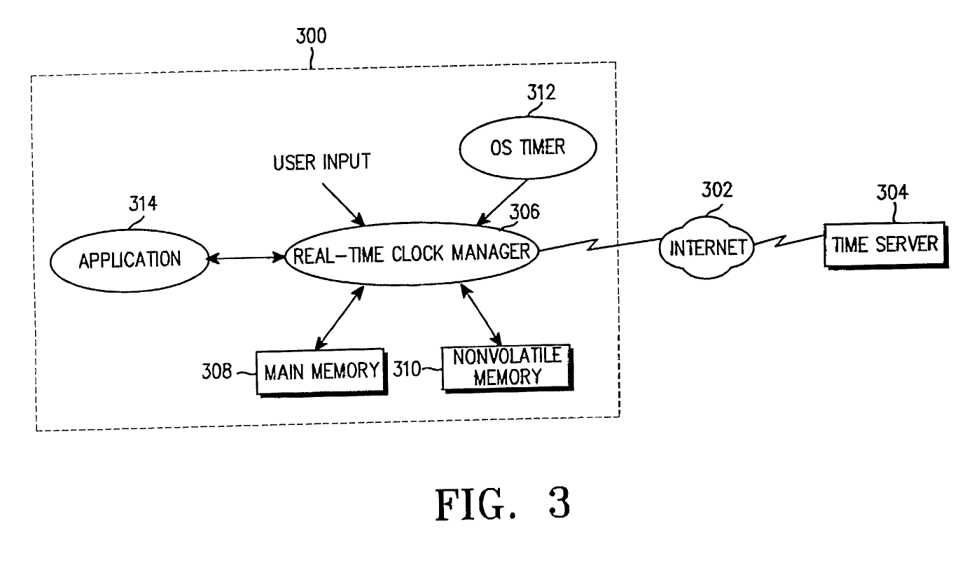

Referring now to FIG. 3, a description of a time information management system constructed as an embodiment according to the principles of the present invention, is applied to an embedded system, such as the webphone.

In the system illustrated by FIG. 3, unlike the embedded system shown by FIG. 1, an embedded system 300 implemented as an embodiment of the present invention accesses a time server 304 through the Internet 302, instead of using the real-time clock device 102. The embedded system 300 acquires real-time information by exchanging messages with the time server 304 through the Internet 302, using SNTP (Simple Network Time Protocol).

The SNTP is a protocol used in transmitting real-time information through a message exchange over the Internet.

The time server 304 is a server for providing the real-time information through the Internet 302. For example, a server provided by a service provider providing the embedded system according to the present invention may become the time server 304, and the time server 304 is subjected to the embedded system 300. In this case, only a specific embedded system provided by the corresponding service provider is accessible to the time server 304.

An OS (Operating System) timer 312 is a software timer for RTOS. The OS timer 312 provides a period alarm, i.e., a time tick, to a real-time clock manager 306. A main memory 308 provides a storage area in which the real-time clock manager 306 stores the time information. The real-time clock manager 306 stores initial time information in the main memory 308 and updates the time information stored in the main memory 308 depending on the time tick periodically generated from the OS timer 312.

A nonvolatile memory 310 is used to store the updated time information of the main memory 308 when the real-time clock manager 306 turns off (inactivates) the system at the request of the user. The most recent updated time information is stored in the nonvolatile memory 310 even though the system is turned off, so the stored updated time information can be used when the system is restarted. The main memory 308 and the nonvolatile memory 310 are included in the memory 204 of FIG. 2.

The embedded system 300 receives current time information input by the user during system initialization, and sets the received current time information as initial time information in the same manner as done in a conventional system. Alternatively, in accordance with the present invention, the embedded system 300 acquires real-time information provided from the time server 304 over the Internet 302, stores the acquired real-time information in the main memory 308 as the initial time information, and then updates the time information depending on operation of the OS timer 312. Here, a time information acquisition source (from which the time information is acquired) is previously defined in configuration information of the embedded system. That is, whether to acquire the initial time information from the user or from the time server 304 is selected depending on the system configuration information. If the time server 304 is selected as the time information acquisition source, an Internet address of the time server 304 is also defined in the system configuration information so that the system can access the time server 304 through the Internet 302.

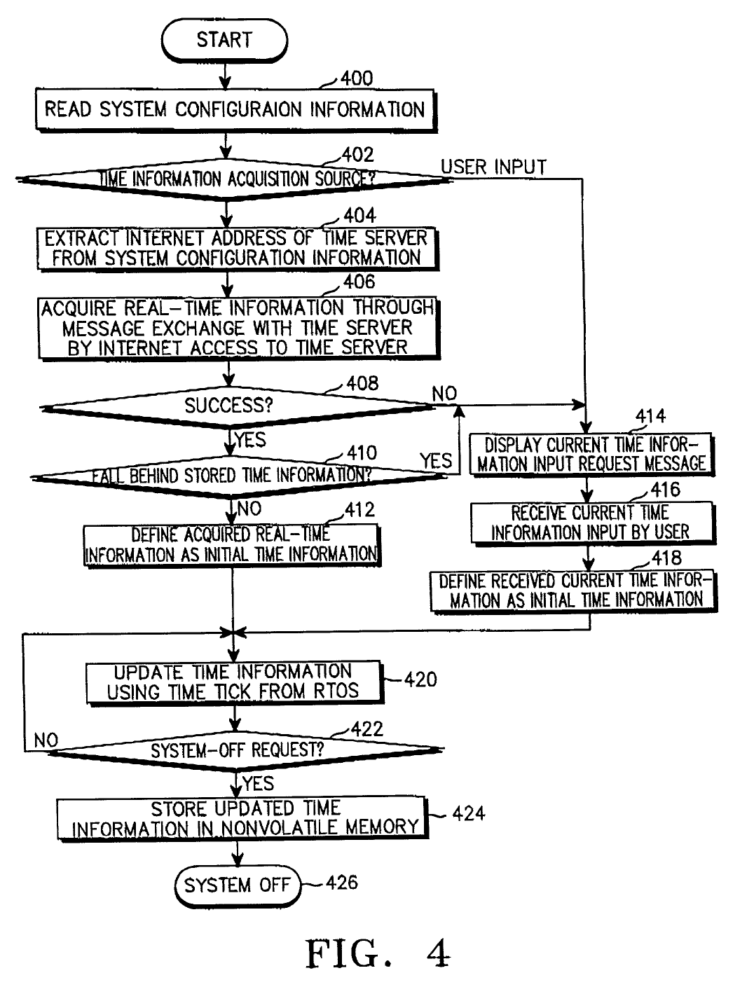

Now, a process of managing the time information by the real-time clock manager 306 according to the embodiment of the present invention will be described with reference to FIG. 4.

Referring to FIG. 4, when the embedded system 300 of FIG. 3 is turned on, the real-time clock manager 306, under the control of the controller 200 of FIG. 2, reads system configuration information in step 400, and determines in step 402 whether the time information acquisition source is the user or the time server 304.

If the time information acquisition source is the user, the real-time clock manager 306 receives the current time information input by the user and defines the received current time information as initial time information in steps 414 to 418. That is, the real-time clock manager 306 displays a current time information input request message through the user interface 202 in step 414, receives current time information input by the user at the sight of the current time information input request message in step 416, and stores the received current time information in the main memory 308 as initial time information in step 418.

Otherwise, if the time information acquisition source is the time server 304, the real-time clock manager 306 extracts an Internet address of the time server 304 from the system configuration information in step 404, and then, accesses the time server 304 over the Internet 302 and acquires real-time information through a message exchange with the time server 304 in step 406.

In step 308 it is determined whether the time information was successfully acquired from the time server. Upon failure, for some reason, to access the time server 304 through the Internet 302 or to successfully acquire the time information from the time server 304, the real-time clock manager 306 proceeds from step 408 to step 414 and the current time information is input by the user, as discussed above with respect to steps 414-418, and stores the received current time information as initial time information.

Otherwise, if it is determined in step 408 that the real-time clock manager 306 succeeded in acquiring the real-time information, it compares, in step 410, the acquired real-time information with the time information stored in the nonvolatile memory 310. As stated above, the time information stored in the nonvolatile memory 310 is time information updated up to when the system is turned off at the request of the user. Thus, if the acquired real-time information falls behind the time information stored in the nonvolatile memory 310, the real-time clock manager 306 discards the acquired real-time information and proceeds to step 414-418.

If the acquired real-time information does not fall behind the time information stored in the nonvolatile memory 310 in step 410, the real-time clock manager 306 stores the acquired real-time information in the main memory 308 as initial time information in step 412.

After defining the acquired real-time information or the current time information input by the user as initial time information, the real-time clock manager 306 updates the time information depending on the time tick provided from the OS timer 312 while the system is turned on, in steps 420 and 422.

In this state, upon receiving a system-off request from the user in step 422, the real-time clock manager 306 stores the time information of the memory 308 updated up to then in the nonvolatile memory 310 in step 424, and then, turns off the system in step 426.

In sum, for the initial time information needed for the embedded system, the real-time clock manager 306 uses the time information acquired from the time server 304 or the current time information input by the user. Thereafter, the real-time clock manager 306 updates the time information depending on the time tick from the OS timer 312 and provides the time information by software, so a real-time clock device 102 becomes unnecessary. In addition, since the real-time clock manager 306 acquires the initial time information from the time server 304, the user is not required to annoyingly input the time information.

Although the present invention has been described with reference to an embodiment where the real-time clock manager selectively acquires the initial time information from the time server 304 or the user, it can acquire the initial time information from only one of the time server 304 and the user. In addition, although the present invention has been described with reference to an embodiment where the updated time information is stored in the nonvolatile memory 310 and used when the system is restarted, the time information of the main memory 308 can be stored in the nonvolatile memory 310 at a predetermined time and used when the system is restarted after hardware reset.

As described above, the present invention provides time information necessary for the embedded system by software, so a real-time clock device is unnecessary, thus contributing to a reduction in hardware complexity and the cost.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for managing time information, comprising the steps of:
during system initialization of an embedded system employing a real-time operating system with an Internet access function, accessing a time server providing real-time information through the Internet;
acquiring the real-time information from the time server through a message exchange with the time server; and
defining the acquired real-time information as the time information and updating the time information depending on a timer operation of the real-time operating system.

2. The method as claimed in claim 1, further comprising the steps of:
storing the updated time information in a nonvolatile memory when the system is turned off at a request of the user or at a predetermined time; and
when the acquired real-time information falls behind the time information stored in the nonvolatile memory, displaying a current time information input request message, and receiving current time information input by the user as the time information.

3. A method for managing time information, comprising the steps of:
during system initialization of an embedded system employing a real-time operating system with an Internet access function, accessing a time server providing real-time information through the Internet;
acquiring the real-time information from the time server through a message exchange with the time server;
upon failure to acquire the real-time information from the time server, displaying a current time information input request message and receiving current time information input by a user responding to the current time information input request message; and
defining the acquired real-time information or the current time information input by the user as the time information and updating the time information depending on a timer operation of the real-time operating system.

4. The method as claimed in claim 3, further comprising the steps of:
storing the updated time information in a nonvolatile memory when the system is turned off at a request of the user or at a predetermined time; and
when the acquired real-time information falls behind the time information stored in the nonvolatile memory, displaying the current time information input request message, and receiving current time information input by the user as the time information.

5. A method for managing time information, comprising the steps of:
during system initialization of an embedded system employing a real-time operating system with an Internet access function, analyzing system configuration information to determine a time information acquisition source;
when the time information acquisition source is a time server providing real-time information, accessing the time server through the Internet;
acquiring the real-time information from the time server through a message exchange with the time server;
when the time information acquisition source is a user or upon failure to receive the real-time information from the time server, displaying a current time information input request message and receiving current time information input by the user; and
defining the acquired real-time information or the current time information input by the user as the time information and updating the time information depending on a timer operation of the real-time operating system.

6. The method as claimed in claim 5, further comprising the steps of:
storing the updated time information in a nonvolatile memory when the system is turned off at a request of the user or at a predetermined time; and
when the acquired real-time information falls behind the time information stored in the nonvolatile memory, displaying the current time information input request message, and receiving current time information input by the user as the time information.

7. A system for managing time information, comprising:
a time server providing real-time information through the Internet; and
an embedded system employing a real-time operating system with an Internet access function, accessing the time server during initialization of the embedded system, acquiring the real-time information from the time server, defining the acquired real-time information as initial time information, and updating the initial time information depending on a timer operation of the real-time operating system.

8. The system as set forth in claim 7, wherein said embedded system comprises:
a real-time clock manager acquiring the real-time information from the time server;
an operating system clock providing said timer operation;
a first memory storing the initial time information; and
a second memory storing the updated time information.

9. The system as set forth in claim 8, wherein said real time manager is configured to transmit a message to the time server to acquire the real-time information from the time server during the system initialization.

10. The system as set forth in claim 8, wherein said real time manager is configured to display a message requiring a user to input a current time as the initial time information during the system initialization.

11. The system as set forth in claim 8, wherein said real time manager is configured to transmit a message to the time server to acquire the real-time information from the time server during the system initialization and to display a message requiring a user to input a current time when said real-time information can not be acquired from the time server.

12. The system as set forth in claim 8, wherein said second memory is a nonvolatile memory.

13. The system as set forth in claim 7, further comprised of said embedded system utilizing Simple Network Time Protocol to acquire said real-time information from said server.
